(19) United States
(12) Patent Application Publication
(10) Pub. No.: US 2007/0124061 A1
(43) Pub. Date: May 31, 2007

(54) Device for the absolute measurement of the linear or rotational position of an object

(76) Inventor: Josef Siraky, Donaueschingen (DE)

Correspondence Address: NATH & ASSOCIATES PLLC, 112 South West Street, Alexandria, VA, 22314, US

(21) Appl. No.: 11/598,234

(22) Filed: Nov. 13, 2006

(30) Foreign Application Priority Data
Nov. 29, 2005 (DE) 10 2005 057 229.4

(51) Int. Cl. G01C 21/00

(52) U.S. Cl. 701/207

(57) ABSTRACT

In the absolute measurement of the position of an object (10) over a plurality of cyclical scannings performed on a material measure, a coding unit (18) is employed to record the cycles. The coding unit (18) is coupled to the measured object (10) by an effective mechanical link (22, 24). The effective link consists of a driving gearwheel (22) and a driven input wheel (24), which belongs to the coding unit (18). To minimize wear on the toothed connection, the connection is allowed a large degree of play and the driven input wheel (24) is run by a motor (26) synchronously with the drive gearwheel (22), as controlled by the scanner (12). The result is that the effective connection occurs within the area of play, without mechanical engagement of the toothings.

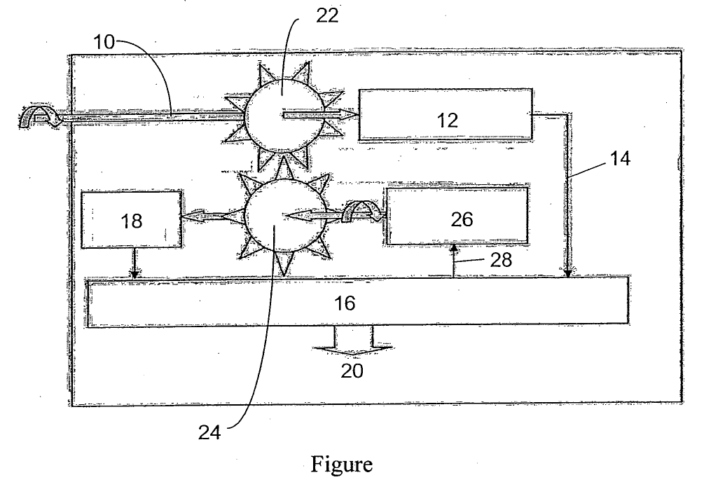

### FIELD OF THE INVENTION

The invention relates to a device for the absolute measurement of the linear or rotational position of an object, in accordance with the preamble of patent claim 1.

### BACKGROUND OF THE INVENTION

To measure the linear or rotational position of an object it is known to couple the measured object with a material measure, which is scanned cyclically by a scanner. When the measured object is a rotating one it is thereby possible to determine the absolute position over several revolutions of the object. When the measured object moves in linear fashion a periodically returning material measure can be scanned over several periods. Here a device is used which records the object's position in coded fashion over a plurality of scanned cycles. To this end, the coding unit exhibits an input wheel, which is coupled to the measured object by an effective mechanical link. The effective mechanical link is generally realized by a toothed gearing. When the object being measured is a rotating one, the input wheel, which takes the form of a gearwheel, engages with the teeth of a gearwheel rotating with the measured object. When the object being measured is moved in linear fashion, the input wheel designed as a gearwheel engages with a toothed bar that is moved with the measured object.

In these known devices a problem is posed by the abrasion or wear that is experienced by the effective mechanical link, particularly by the gearings that engage with each other. In many cases this problem is a serious one, specifically because the abrasion is strongly dependent on the toothed pairing that creates the effective link. The greater the diameter of the driving gearwheel compared to the diameter of the driven input wheel, the greater is the abrasion. For structural reasons the diameter of the driving gear is often considerably greater than the diameter of the driven input wheel. For example, the diameter of the driving gearwheel must have a relatively large diameter if this driving gearwheel is positioned on, e.g., the hollow-shaft motor that represents the measured object. The diameter of the input wheel of the counting device, on the other hand, is usually small, in order to reduce the structural dimensions of the apparatus. In the extreme case of a measured object moved in linear fashion, the linear toothing corresponds to an infinitely large diameter on the driving gearwheel.

### BRIEF SUMMARY OF THE INVENTION

The invention is based on the problem of creating a device which records the object's position in coded fashion over a plurality of scanned cycles, while minimizing the problem of attrition in the mechanical coupling of the coding unit.

The invention solves this problem with a device exhibiting the features of patent claim 1.

Advantageous embodiments of the device are indicated in the secondary claims.

The basic idea of the invention consists in providing a relatively large degree of mechanical play to the effective mechanical link for driving the input wheel of the coding unit and in allowing the input wheel to be driven by its own electrical motor. The scanning of the material mass allows the drive of the input wheel by this motor to be synchronized with the motion of the measured object in such a way that the effective mechanical link occurs within this degree of play, with this result that there is no mechanical engagement which would cause attrition. During operation of the device the effective mechanical link between the measured object and the input wheel is non-functional and the input wheel is driven exclusively by its own motor. The effective mechanical link is replaced by the synchronization provided by this motor drive. If the measured object is moved without the device being switched on, the input wheel is not driven by the electrical motor. In this case, the effective link is mechanically engaged and drives the input wheel and thus the coding unit. The coding unit thereby records the number of rotations or cycles in conventional fashion, in order to determine the absolute position during the subsequent engagement of the device.

### BRIEF DESCRIPTION OF THE DRAWING

The FIGURE shows an embodiment of a device according to the present application for the absolute measurement of the linear or rotational position of an object.

### DETAILED DESCRIPTION OF THE INVENTION

Next the invention will be described in greater detail on the basis of an exemplary embodiment, which is depicted schematically in the single FIGURE of the attached drawing.

In the schematic depiction the absolute angular position of a measured object 10 is be measured over a number of rotations. The measured object 10 can be, e.g., the shaft of a servomotor or a rotating object that requires positioning. The measured object 10 can also be the input shaft of a positional indicator, which is coupled to such a servomotor shaft or such an object being positioned.

Coupled to the measured object 10 in angularly secure fashion is a material measure, which the figure does not depict. The material measure can be, e.g., a coding disk, which is connected to the measured object 10 in torque-proof fashion and is scanned either optically, magnetically, or in some other fashion. The scanner 12 detects in absolute fashion the angular position of the material measure, and thus of the measured object 10, over one rotation of the material measure. The signal given by the scanner 12 is fed to an electronic evaluating unit 16 over a signal line 14.

In order to absolutely determine the angular position of the measured object 10 over a plurality of rotations, there is a coding unit 18, which detects and encodes the rotations of the measured object 10, or of the material measure, through use of a reduction gear. The coded information on the number of rotations is also fed to the evaluating unit 16. In the evaluating unit 16, the information on the position within a rotational cycle and the information on the number of rotations are consolidated into the absolute multi-turn positional value, which is then released by an interface 20.

The device thus far accords with the prior art, and a detailed description is not necessary.

The coding unit 18 is coupled to the measured object 10 over an effective mechanical link. To this end, a gearwheel 22 is connected to the measured object 10 in torque-proof fashion. Engaging with the gearwheel 22 is an input wheel 24, in the form of a gearwheel belonging to the coding unit 18. The toothings of the gearwheel 22 and of the input wheel 24 are designed so as to mutually engage with a relatively large degree of play in the rotating direction. The rotation of the input wheel 24 is driven by an electric motor 26 belonging to the input wheel 24. The motor 26 is piloted by the evaluating unit 16 over a control line 28, in such a way that the input wheel 24 rotates synchronously with the gearwheel 22. The scanning signals of the scanner 12 are used to achieve this synchronization.

When the device is running and the evaluating unit 16 and the motor 26 are operating, the synchronized rotation of the input wheel 24 and the gearwheel 22, in conjunction with the relatively large degree of play between the teeth, ensure that the toothings of the driving gearwheel 22 and the driven input wheel 24 do not engage and transmit a drive torque. As a result, there is almost no wear on the toothings.

If the measured object 10 is moved when the device is not operating, the material measure and the gearwheel 22 are rotated with the measured object 10. Because the toothings are engaged, the gearwheel 22 entrains the input wheel 24, which in this case is not driven by the motor 26, because the latter is shut off. The engagement of the gearwheel 22 with the input wheel 24 actuates the coding unit 18, and the revolutions of the measured object 10 are recorded in coded form. When the device is later turned on, the absolute angular position measured over a plurality of revolutions is thus immediately available at the interface.

It is evident that the invention can be employed in the same manner when the measured object 10 is not a rotating object, but an object moving in linear fashion. Here the material measure can be positioned in a linear way, and the absolute positional values repeat periodically and succeed each other cyclically during scanning. The coding unit 18 serves to absolutely record the scanned cycles in coded fashion.

When the invention is applied in this way a linear gearing is used instead of a rotating gearwheel 22, e.g., in the form of a toothed bar connected to the measured object. The toothed bar then engages with the input wheel, with an appropriate degree of play between the gearings.

### LIST OF REFERENCE NUMERALS

10 measured object
12 scanner
14 signal line
16 electronic evaluation unit
18 coding unit
20 interface
22 gearwheel
24 input wheel
26 motor
28 control line

1. A device for the absolute measurement of the linear or rotary position of an object, with a material measure which is coupled to the measured object (10) and is scanned cyclically by a scanner (12), and with a coding unit (18) which records the position of the material measure over a plurality of scanned cycles, such that the coding unit (18) exhibits an input wheel (24) which is coupled to the measured object (10) by an effective mechanical link,
wherein
the effective mechanical link is provided with a degree of play, the input wheel (24) can be driven by an electric motor (26), and the motor (26) drives the input wheel (24) synchronously with the measured object (10), as controlled by the scanning (12) of the material measure, so that the effective link occurs within the area of play, without effective mechanical engagement.

2. A device according to claim 1,
wherein
the input wheel (24) is a gearwheel which engages with a toothing (gearwheel) 22 coupled to the measured object (10), to create an effective mechanical link that allows play between the teeth of the gearings.

3. A device according to claim 2,
wherein
the diameter of the toothing of the input wheel (24) is smaller than the diameter of the toothing coupled to the measured object (10).

4. A device according to claim 3,
wherein
the measured object (10) is a rotating object, coupled to which is a gearwheel to provide the effective link.

5. A device according to claim 3,
wherein
the measured object is an object moving in linear fashion, coupled to which is a linear toothing to provide the effective mechanical link.
